(19) United States
(12) Patent Application Publication
(10) Pub. No.: US 2006/0184895 A1
(43) Pub. Date: Aug. 17, 2006

(54) Visibly persisting one or more computer desktop windows

(76) Inventor: Blaine H. Dolph, Western Springs, IL (US)

Correspondence Address: DILLON & YUDELL LLP, 8911 N. CAPITAL OF TEXAS HWY.,, SUITE 2110, AUSTIN, TX, 78759, US

(21) Appl. No.: 11/060,340

(22) Filed: Feb. 17, 2005

(51) Int. Cl. G06F 17/00

(52) U.S. Cl. 715/790; 715/792; 715/794

(57) ABSTRACT

A method and system for allowing selected applications to be visually persistent without obscuring or being obscured by other visually non-persistent applications is presented. Selected visually persistent applications are permanently assigned a first portion of a Graphical User Interface (GUI) display area. Subsequently opened visually non-persistent applications are then assigned a remaining second portion of the GUI display, such that there is no display overlap between visually persistent and non-persistent applications.

### BACKGROUND OF THE INVENTION

1. Technical Field

The present invention relates in general to the field of computers, and in particular to computer software. Still more particularly, the present invention describes a method that allows an application window to be persistently visible on a computer desktop when subsequent applications are opened.

2. Description of the Related Art

During the course of a day, a computer user may open and close computer applications dozens and even hundreds of times. Oftentimes, the user will desire that one or more of the applications remain visible on the computer's desktop at all times. An application having such constant visibility is referred to as being visibly persisting.

A problem with visible persistence of an application occurs when a new application is opened, causing the new application to obscure the visibly persisting application. It is also problematic for the visibly persisting application to obscure all or some of the newly opened application. For example, consider a Graphical User Interface (GUI) 100 depicted in FIG. 1. Application 1 and Application 2 are visibly persistent (a.k.a., “visibly persisting” or “visually persistent”). Application 1 may be a text messaging application that includes a text message box 102, and Application 2 may be a Compact Disk (CD) player program that includes an on-screen audio control 104. Subsequent to opening persistent Applications 1 and 2, Application 3 is opened, as indicated by an accented program button 106 and a title bar 108. Application 3 may be a browser program, a word processing program, or any other visible application. Note that when Application 3 opens, even in a partial tile format as indicated by a restore down button 110, the persistent Application 1 is partially obscured (including its text message box 102). At the same time, Application 2, which has invoked an “always on top” option, is partially obscuring Application 3.

Thus, there is a need for a method and system that allows visibly persisting applications to always be visible on a computer's GUI, while neither obscuring nor being obscured by subsequently opened non-persistent applications.

### SUMMARY OF THE INVENTION

The present invention is thus directed to a method and system for allowing selected applications to be visually persistent without obscuring or being obscured by other visually non-persistent applications. Selected visually persistent applications are permanently assigned a first portion of a Graphical User Interface (GUI) display area. Subsequently opened visually non-persistent applications are then assigned a remaining second portion of the GUI display, such that there is no display overlap between visually persistent and non-persistent applications.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a prior art Graphical User Interface (GUI) having obscured windows;

FIG. 2 depicts an exemplary computer system that may be utilized by the present invention;

FIGS. 3a-c demonstrate a GUI using the present invention to ensure that persistent windows are not obscured or obscuring; and

FIG. 4 is a flow-chart of steps taken in a preferred embodiment of the present invention.

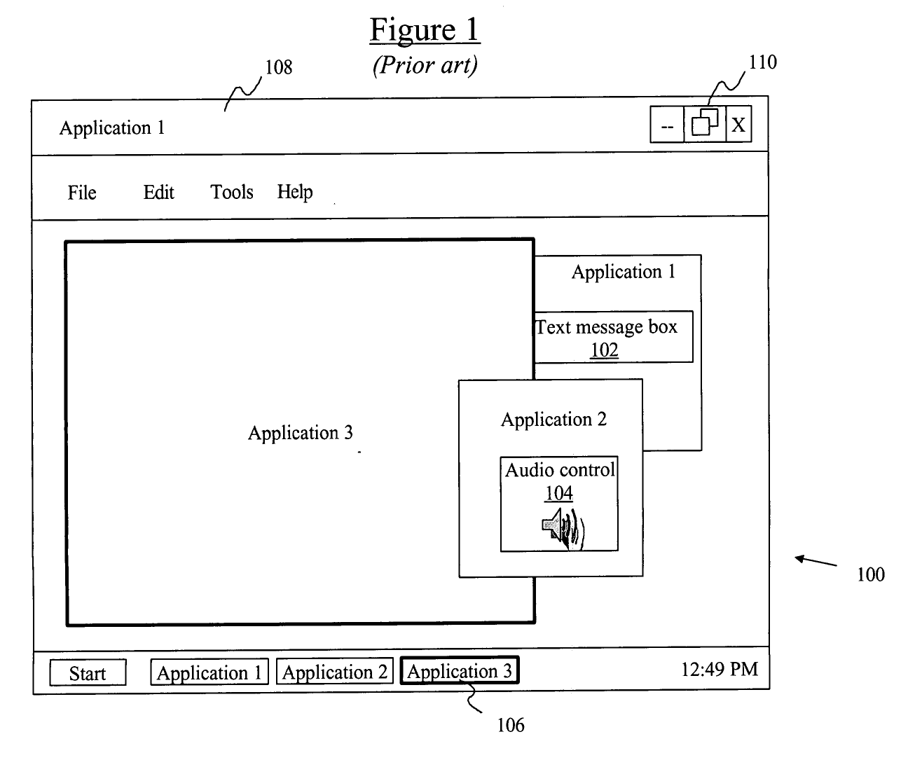

### DETAILED DESCRIPTION OF THE PREFERRED EMBODIMENT

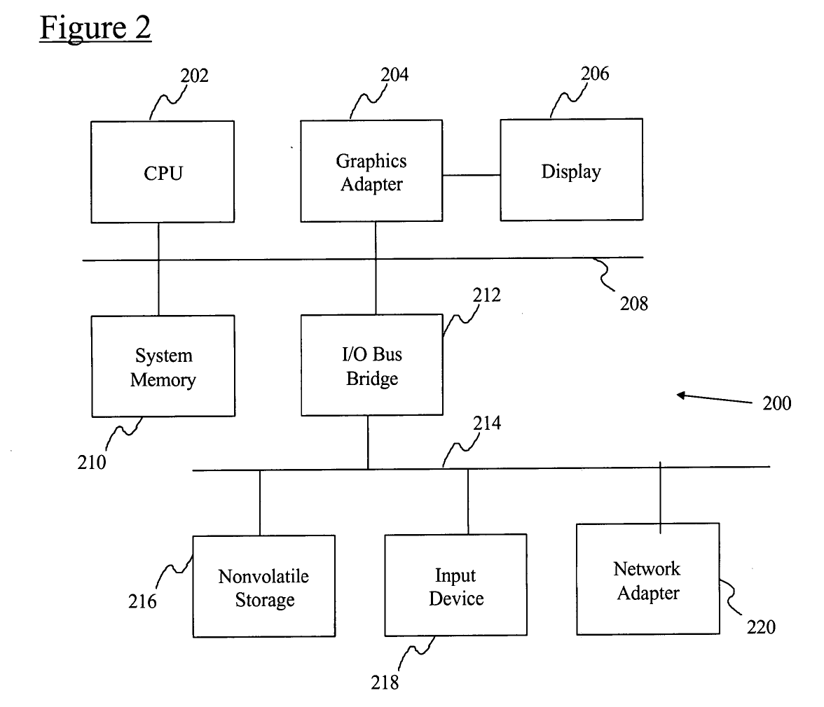

With reference now to FIG. 2, there is depicted a block diagram of an exemplary data processing system in which a preferred embodiment of the present invention may be implemented. Data processing system 200 may be, for example, one of the models of personal or server computers available from International Business Machines Corporation of Armonk, N.Y. Data processing system 200 includes a central processing unit (CPU) 202, which is connected to a system bus 208. In the exemplary embodiment, data processing system 200 includes a graphics adapter 204 also connected to system bus 208, for providing user interface information to a display 206.

Also connected to system bus 208 is a system memory 210, and an input/output (I/O) bus bridge 212. I/O bus bridge 212 couples an I/O bus 214 to system bus 208, relaying and/or transforming data transactions from one bus to the other. Peripheral devices such as nonvolatile storage 216, which may be a hard disk drive, and input devices 218, which may include a conventional mouse, a trackball, or the like, or, especially in the present invention, a scanner, are connected to I/O bus 214. Also connected to I/O bus 214 is a network interface 220, which affords data communication between a (not shown) local or wide area network connection (including the Internet) and data processing system 200.

The exemplary embodiment shown in FIG. 2 is provided solely for the purposes of explaining the invention and those skilled in the art will recognize that numerous variations are possible, both in form and function. For instance, data processing system 200 might also include a compact disk read-only memory (CD-ROM) or digital versatile disk (DVD) drive, a sound card and audio speakers, and numerous other optional components. All such variations are believed to be within the spirit and scope of the present invention.

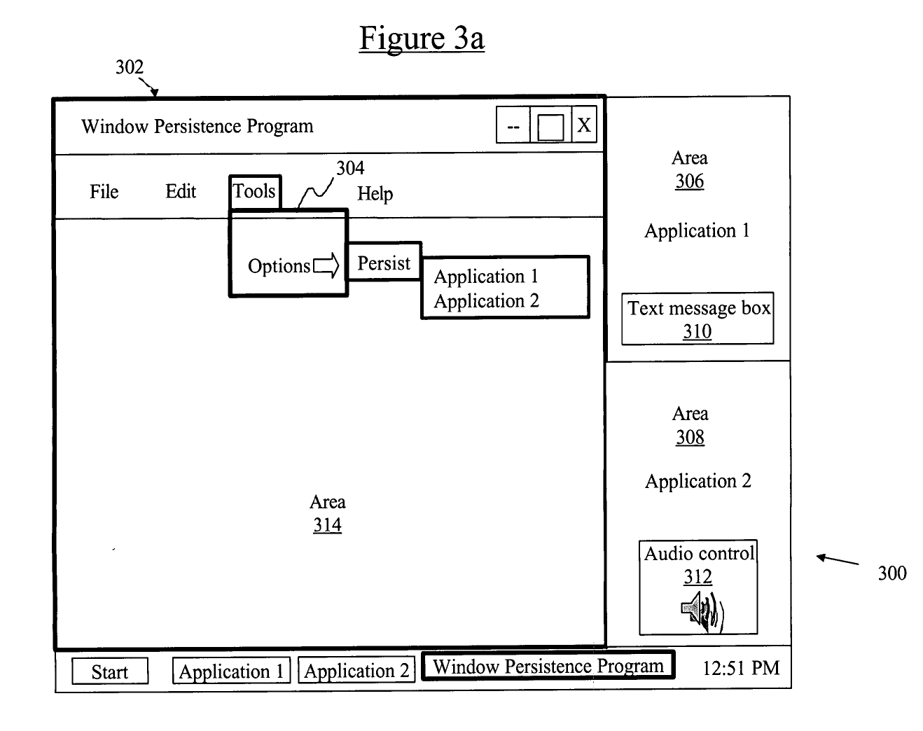

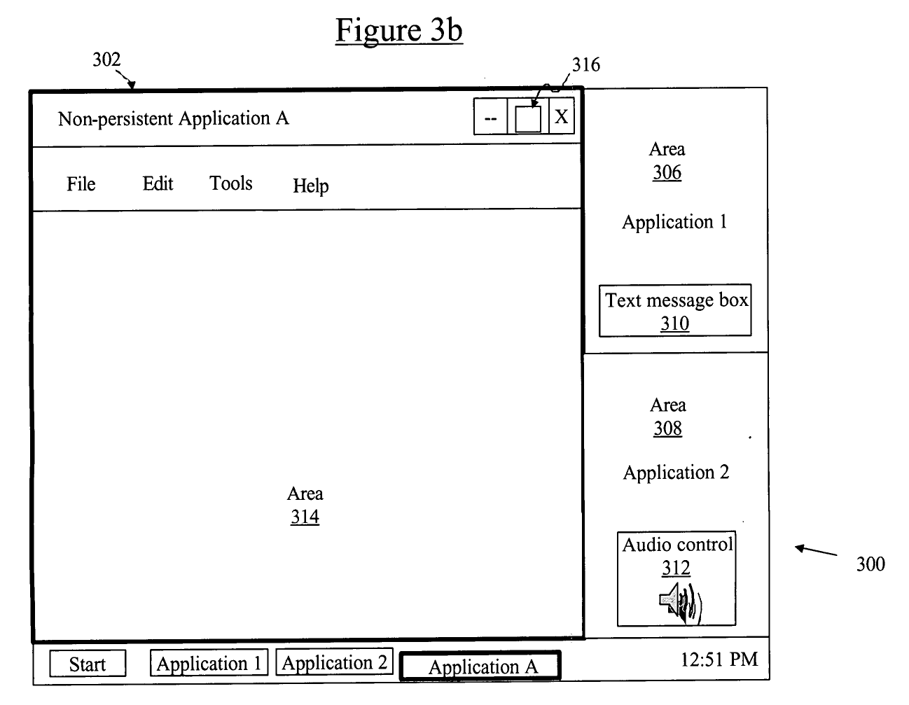

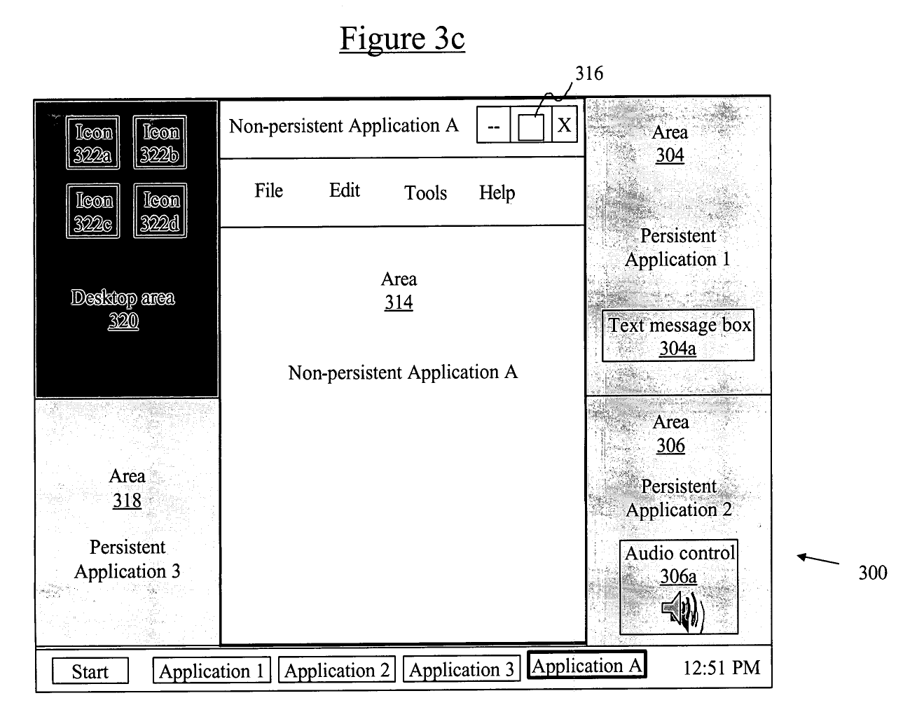

With reference now to FIG. 3a, there is depicted a Graphical User Interface (GUI) 300 displaying features of the present invention. A window persistence program is running, as indicated by a title window 302. This window persistence program includes a drop down window 304, which includes a “Persist” option. Assuming that the user has opened Application 1 and Application 2, then that user can select one or both of these applications to be visually persistent. In the example shown in FIG. 3a, the user has selected both Applications 1 and 2 to be visually persistent. Thus, by using techniques known to those skilled in the art for defining specific screen areas, Application 1 has been permanently designated to be displayed in an area 306 while Application 2 has been permanently assigned an area 308. Assume for exemplary purposes that Application 1 is a text messaging program, and Application 2 is an audio program for listening to CD's on the computer. Note that all portions of Applications 1 and 2, including their respective text message box 310 and audio control 312 are completely visible, without being obscured at all.

After assigning areas 306 and 308 to visually persistent applications, the remaining display area of GUI 300 is an area 314, which is now reserved for future applications to be displayed. These future applications, which are preferably visually non-persistent applications, can thus be opened/closed and/or minimized/maximized without being or causing visual obscuring. For example, as shown in FIG. 3b, a non-persistent Application A is displayed in area 314. Note that while Application A is maximized, as indicated by a maximize button 316, Application A only takes up area 314 in GUI 300.

Alternatively, other arrangements for persistent and non-persistent applications are possible. For example, as shown in FIG. 3c, a third persistent application 3 may have been selected in addition to persistent applications 1 and 2. The present invention may offer an option to allow at least a partial view of a desktop area 320, including icons 322. Thus area 314, available to non-persistent applications, is only what remains in GUI 300 after reserving areas 304, 306, and 318 for persistent applications, and desktop area 320 for the desktop display. Nonetheless, area 314 still provides a full, although confined, view of non-persistent Application A, even though non-persistent Application A is maximized, as indicated by maximize button 316.

Note that area 314 shown in FIG. 3c has been resized to accommodate area 318 and desktop area 320. This resizing, as well as the sizing of the reserved areas, are performed by algorithms in the graphics adapter 204 shown in FIG. 2, using modified driver software in accordance with the present invention. The modification of this software to facilitate the presently described invention uses programming techniques known those skilled in the art of driver and display software, and will not be detailed herein.

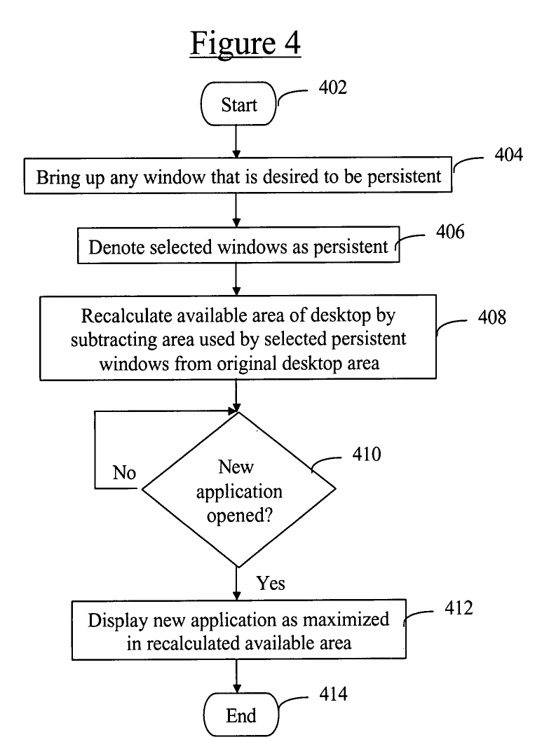

Referring now to FIG. 4, a flow-chart of preferred steps taken by the present invention is presented. After initiator block 402, any applications that the user wishes to persistently display are brought up (block 404) either by simply executing the program or by displaying a window for the program in the GUI. The programs that are to be persistently displayed are chosen (block 406), causing a graphic adapter to assign a permanent area of the GUI to the selected persistently displayed applications, and to reserve the remaining display area of the GUI for future non-persistently displayed applications (block 408). Subsequently, if a new application is opened (query block 410), then that new application is displayed in the reserved area based on the recalculations described above (block 412). Assuming that no new visually non-persistent applications are to be opened, the process ends (terminator block 414).

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method comprising:
selecting one or more applications windows to be persistently displayed on a Graphical User Interface (GUI);
assigning a first area in the GUI for a display of the selected applications windows; and
reserving a second area in the GUI for a display of a non-persistently displayed application, wherein the first and second areas do not overlap.

2. The method of claim 1, wherein the non-persistently displayed application does not obscure any portion of the persistently displayed selected applications when the non-persistently displayed application is maximized.

3. The method of claim 1, wherein the first area includes an area reserved for a desktop display as well as another persistently displayed application.

4. A system comprising:
means for selecting one or more applications windows to be persistently displayed on a Graphical User Interface (GUI);
means for assigning a first area in the GUI for a display of the selected applications windows; and
means for reserving a second area in the GUI for a display of a non-persistently displayed application, wherein the first and second areas do not overlap.

5. The system of claim 4, wherein the non-persistently displayed application does not obscure any portion of the persistently displayed selected applications when the non-persistently displayed application is maximized.

6. The system of claim 4, wherein the first area includes an area reserved for a desktop display as well as another persistently displayed application.

7. A computer program product, residing on a computer usable medium, comprising:
program code for selecting one or more applications windows to be persistently displayed on a Graphical User Interface (GUI);
program code for assigning a first area in the GUI for a display of the selected applications windows; and
program code for reserving a second area in the GUI for a display of a non-persistently displayed application, wherein the first and second areas do not overlap.

8. The computer program product of claim 7, wherein the non-persistently displayed application does not obscure any portion of the persistently displayed selected applications when the non-persistently displayed application is maximized.

9. The computer program product of claim 7, wherein the first area includes an area reserved for a desktop display as well as another persistently displayed application
